(19) United States
(12) Patent Application Publication
(10) Pub. No.: US 2021/0204588 A1
(43) Pub. Date: Jul. 8, 2021

(54) Vaporizable Tobacco Wax Compositions and Container thereof

(71) Applicant: BOND STREET MANUFACTURING LLC, Nashville, TN (US)

(72) Inventors: Joseph M. Fuisz, Nashville, TN (US); Seamus Henry, Fort Lauderdale, FL (US)

(21) Appl. No.: 17/188,454

(22) Filed: Mar. 1, 2021

Related U.S. Application Data
(63) Continuation of application No. 15/403,472, filed on Jan. 11, 2017.
Application No. 15/403,472 is a continuation-in-part of application No. 15/276,902, filed on Sep. 27, 2016, now Pat. No. 10,709,165.

(51) Int. Cl. A24B 15/167; A24B 15/24; A24B 15/32; A24F 40/42; A24F 40/485

(52) U.S. Cl. CPC A24B 15/167; A24B 15/24; A24B 15/32; A24F 40/20; A24F 40/485; H05B 2203/02; H05B 2203/021; A24F 40/42

(57) ABSTRACT

A system for a personal vaporizer includes a receiving chamber and a pod containing a tobacco wax composition including tobacco wax extracted from one or more of tobacco leaf, tobacco stem or tobacco dust. The pod is in contact with the receiving chamber.

### CROSS-REFERENCE TO RELATED APPLICATION

This application is a continuation of application Ser. No. 15/403,472, filed Jan. 11, 2017, which is a continuation-in-part of application Ser. No. 15/276,902, filed Sep. 27, 2016, now U.S. Pat. No. 10,709,165 the content of each of which is incorporated herein by reference.

### BACKGROUND OF THE INVENTION

In 1926, Samual Amster of Richmond, Kentucky described the extraction of a “wax like substance” from tobacco using a hot water process and then subjecting the resulting liquor to an evaporative step. Despite this extraction, Amster teaches that the (extracted) tobacco “may still be employed for smoking and chewing tobacco.” Amster teaches the use of the tobacco “wax like substance” in candles, shoe polishes and varnish (U.S. Pat. No. 1,624,155).

In 1936, James Gamer of Mount Lebanon, Pa., described a method to de-nicotinize tobacco, whereby ammonia treated tobacco is subjected to a butane-solvent based extraction method. When the butane is evaporated, “there is left a mass of nicotine and tobacco wax which together may amount to as much as 6-8% by weight of the tobacco used . . . . Tobacco wax or resin is dark brown in color, burns with the production of acrid fumes, and has a strong odor resembling that of an “old” pipe.” The tobacco wax may be used as an insecticide or may be “returned to the residual tobacco leaves and also to untreated tobacco leaves to impart thereto desirable flavors.” Like Amster, Gamer teaches that the extracted tobacco is still suitable use in smoking and other tobacco products (U.S. Pat. No. 2,128,043).

Despite this eighty year old work, Applicants are not aware that the teachings of Amster or Garner have been used in commercial processes or products.

Entering the present era, Keritsis et al (assigned to Philip Morris) (U.S. Pat. No. 4,936,920)(1990) mentions tobacco wax in a list of saccharides and polysaccharides that may be used as a bonding agent when making manufactured tobacco (more typically referred to as reconstituted tobacco sheet).

Renaud et al., in U.S. Pat. No. 8,863,754 (assigned to Philip Morris) (2014) describe compositions for heat not burn applications. The patent mentions tobacco wax in a reference to degradation products the presence of which evidences (unwanted) combustion: “Isoprene is a pyrolysis product of isoprenoid compounds present in tobacco, for example in certain tobacco waxes, and can be present in the aerosol only if the strands of homogenized tobacco material are heated to a temperature substantially higher than that required to generate an aerosol. Thus, isoprene yield can be taken as representative of the amount of homogenized tobacco material that is “over heated.”” Nothing in the disclosure indicates that tobacco wax has been purposefully used in this composition or otherwise present than through the natural presence of wax in the tobacco used to manufacture the “homogenized tobacco material.” Applicant understands the substrate described in this art to be a reconstituted tobacco sheet intended for use in heat not burn applications.

Brown et al. (assigned to Lorillard)(U.S. Pat. No. 9,038,644)(2015) teaches tobacco wax for use as a phase transition material to impart reduced ignition propensity to a cigarette. The wax is applied to the cigarette paper using high precision wax jet printing.

Each of U.S. Pat. Nos. 1,624,155; 2,128,043; 4,936,920; 4,936,920; 8,863,754; and 9,038,644, is expressly incorporated herein together with all citations in these references.

The vaporization of nicotine containing liquids is well known and popular, including using devices such as electronic cigarettes and tank-style (and non tank) personal vaporizers. Typically such compositions include USP (99.9% pure) nicotine oil as an ingredient, though zero-liquids without any nicotine are also used.

Heat not burn tobacco systems are known in the tobacco industry. Heat not burn systems like Pax Lab's Pax® and Philip Morris' IQOS® (as well as earlier versions of IQOS® sold as Heatbar® and Accord®) heat tobacco compositions substantially without burning the tobacco, thereby aerosolizing volatile constituents of the tobacco composition. After use, the non-vaporized components of the tobacco composition remain minus those components what were successfully vaporized (or inadvertently burned).

In the case of both Pax® and IQOS® this residue is substantial and represents the substantial mass of the original tobacco composition.

Philip Morris International (PMI) describes the rationale behind heat not burn systems thusly: “[t]he concept behind ‘heat-not-burn’ is that heating tobacco, rather than burning it, reduces or eliminates the formation of many of the compounds that are produced at the high temperatures associated with combustion. Research has demonstrated that most of the harmful and potentially harmful constituents (HPHCs) in cigarette smoke are formed by thermal breakdown of the tobacco when it is burned. Heat-not-burn therefore offers the possibility of significantly reducing both the number and the levels of HPHCs generated by tobacco products, whilst retaining an acceptable sensory experience for current adult smokers” (from pmiscience.com).

Now, some criticism has been leveled against heat not burn systems, which ostensibly is premised on the notion that tobacco and heat will always tend lead to toxicant formation. Stephen Stotesbury, head of scientific and regulatory affairs for Imperial Tobacco has been quoted saying about Philip Morris International's IQOS [heat not burn] system: “There's a lot of black crud in the iQOS device after using it . . . . It smells like an ashtray.” Perhaps not surprisingly, Imperial Tobacco has stated it will not develop a heat not burn product—presumably to rely solely on its electronic nicotine delivery systems (ENDS).

Pax is a loose-leaf style vaporizer for use with “loose-leaf plant material” supplied by the user herself (https://www.paxvapor.com/support/pax-2-faq/#can-i-use-liquids-in-pax-2). An earlier heat not burn composition—Pax Labs' Ploom® used a tobacco-humectant composition contained in nescafe style pod—however this product has been discontinued.

Philip Morris' IQOS is a more sophisticated product wherein the user uses a manufacturer-supplied “cigarette” in the heating device. The cigarette itself is comprised of reconstituted tobacco sheet made with high amounts of humectant (glycerin) that, together with other volatiles, create a vapor like experience when used.

Applicants believe the composition of the reconstituted sheet used in IQOS is akin to that described in WO2016050472A1, assigned to Philip Morris. One of the present inventors has extensive experience working with film and sheet systems, principally for pharmaceutical applications and is a named inventor on Fuisz et al. U.S. Pat. Nos. 9,108,340; 8,906,277; 8,685,437; 8,663,687; 8,652,378; 8,617,589; 8,613,285; 8,603,514; 8,241,661; 8,017,150; 7,972,618; 7,897,080; 7,824,588; 7,666,337; and 7,425,292.

Heat not burn systems does reduce HPHCs as stated by the PMI Science excerpt above. The toxicant profile of burning tobacco is well understood. Researchers have estimated that cigarette smoke contains 7,357 chemical compounds from many different classes (Warnatz, J, U Maas and R W Dibble. Combustion: physical and chemical fundamentals, modeling and simulation, experiments, pollutant formation. 2006). There is broad scientific agreement that several of the major classes of chemicals in the combustion emissions of burned tobacco are toxic and carcinogenic (Rodgman, A, and TA Perfetti. The chemical components of tobacco and tobacco smoke. 2013: CRC press).

### BRIEF DESCRIPTION OF THE DRAWING

FIG. 1 shows an exploded view of the system for a personal vaporizer of the present invention including a receiving chamber and a pod; and

FIG. 2 shows a cross-sectional view of the receiving chamber and pod.

### BRIEF SUMMARY OF THE INVENTION

This invention is directed towards tobacco wax, including methods of manufacture, tobacco wax compositions, and the vaporization of tobacco wax for use in a vaporizer-inhalation device. The present invention also relates to a portion-sized container (“pod”) of a tobacco wax composition for administration to a mammal or person. The pod is intended for use in a personal (or other) vaporizer.

One aspect of the invention is directed to a system for a personal vaporizer comprising a receiving chamber and a pod containing tobacco wax, the pod that being in contact with the receiving chamber.

The pod can have side airholes that align with side airholes of the receiving chamber.

The receiving chamber can serve as the heat source and can use a Curie point so that an upper threshold temperature is not exceeded.

The receiving chamber can have an alignment interface.

The receiving chamber can have airholes that are less than 4 mm from the a starting product fill level of the tobacco wax in the pod.

### DETAILED DESCRIPTION OF THE INVENTION

The present invention teaches a composition that comprises tobacco wax and other ingredients suitable for vaporization and use by a mammal. Applicants have found that the vaporization of a tobacco wax based composition provides excellent organaleptics and nicotine delivery. Moreover, unlike existing heat not burn compositions, applicants have found tobacco wax compositions of the present invention vaporize substantially in their entirety (i.e. substantially without residue). It is one of the intentions of the present invention to make a heat not burn format that does not rely on a reconstituted sheet approach. This avoids the need for agents that are, one the one hand needed to make reconstituted sheet (e.g. a film former), but are not themselves vaporizable and may have undesirable organoleptic profiles.

Tobacco wax based compositions allow for a heat-not-burn tobacco product that is not a readily flowable liquid (like an e-liquid), and does not require specialized reconstituted sheet production or use, or use conventional tobacco leaf inpuy (like Pax).

The role of plant wax for plants is understood. Plants secrete waxes into and on the surface of their cuticles as a way to control evaporation, wettability and hydration. The epicuticular waxes of plants are mixtures of substituted long-chain aliphatic hydrocarbons, containing alkanes, alkyl esters, fatty acids, primary and secondary alcohols, diols, ketones, aldehydes. From the commercial perspective, the most important plant wax is carnauba wax, a hard wax obtained from the Brazilian palm Copemicia prunifera.

B. R. Jordan describes tobacco wax as consisting of three major components: straight chain hydrocarbon (C27-C33 comprising 59%); branched-chain hydrocarbons (C25-C32 comprising 38%) and fatty acids (C14-C18 comprising 3%) (Advances in Botanical Research, Vol 22, “UV-B Radiation: A Molecular Perspective, hereby incorporated by reference as if fully set forth herein).

Various processes for extracting wax from plant materials can be employed in connection with the present invention. These extraction methods include, without limitation, subcritical CO2 extraction; supercritical CO2 extraction; supercritical extraction with additional (non-CO2) solvents; maceration; digestion (a heated form of maceration); decoction; percolation; hot continuous extraction (Soxlet); aqueous alcoholic extraction by fermentation; counter-current extraction; ultrasound extraction (sonication); and the phytonics process. This list is non-limitative as skilled artisans will appreciate and other suitable extraction methods may be employed. Solvents used may be polar or non-polar. Various combinations and/or sequential series of these methods can be used. The tobacco may be pre-treated prior to extraction, including to enhance flavor and/or nicotine during extraction. Post processing may be employed to concentrate desirable elements of the extraction and/or remove undesirable elements (e.g. TSNAs).

The non-limitative preferred embodiment is supercritical CO2 extraction. The use of supercritical CO2 extraction to de-nicotinize tobacco is disclosed in Howell et al U.S. Pat. No. 8,887,737 (2014), which is hereby incorporated by reference as if fully set forth herein.

Extraction, including the preferred embodiment supercritical CO2 extraction, can be used to generate several partitions form tobacco, broadly speaking, including oils and waxes (which may comprise oleoresins). Both of these partitions contain nicotine. The wax partition yield should exceed 1.0% of the starting tobacco weight, preferably 2% or greater, most preferably 4% of greater.

All forms of tobacco may be used including tobacco leaf, stem, and waste tobacco dust. Blends of tobacco may be employed. Cigar tobaccos may be employed. Tobacco varieties with high nicotine content are preferred. Because the extraction process may bring flavors and aromas from the leaf into the wax and oil, the tobacco inputs may be selected in whole or in part for taste. For example, a cigarette blend may be employed, of flue cured, burley and Turkish tobaccos.

It is expressly contemplated that oils from the (or separate) extractions may be mixed into the resulting wax to increase the yield of the tobacco composition, and nicotine. High shear mixers (and other mixing methods) may be used for this purpose. Preferably, the mass of the oil partition added to the wax partition will be less than or about 75% of the mass of the wax partition, preferably less than or about 30% and most preferably less than 15% of the mass of the wax partition (measured by mass). The oil partition can serve to increase nicotine, enhance flavor, increase vapor production and generally extend the yield of the wax composition from the starting tobacco.

Additional excipients may be employed to develop a final composition for vaporization.

Vapor agents may be added to the wax. Vapor agents increase the vapor from the composition when heated. Vapor agents may include, without limitation, vegetable glycerin, non-vegetable forms of glycerin, propylene glycol, polyethylene glycol, polysorbates including polysorbate 20 (polyoxyethylene sorbitan monolaurate), polysorbate 40 (polyoxyethylene (20) sorbitan monopalmitate), polysorbate 60 (polyoxyethylene sorbitan monostearate) and polysorbate 80 (polyoxyethylene sorbitan monooleate), and other agents suitable for increasing the “vapor” from a heated composition. Vapor agents may be added to about 70% of the composition (by mass), preferably 30-60% of the composition (by mass). High shear mixing is important to ensure uniform distribution of the vapor agent (or other added excipient in the composition.

The nicotine content of the final composition is preferably less than 12%, more preferably less than 7.5% and most preferably 1.4% (by mass). Low nicotine compositions with nicotine less than 1.0% may also be made for users seeking lower nicotine delivery. Nicotine, natural or synthetic, may be added where the tobacco extraction yields a less than desired level. The product can be made from low-nicotine containing tobacco to achieve a low nicotine level, or otherwise subject to known processes to dinicotinize the composition.

Flavors may be added to the wax. Flavors may be synthetic or natural. For purposes hereunder, menthol, wintergreen, peppermint and similar oils used in menthol tobacco products are understood to be flavors, together with traditional flavors (e.g. grape, cherry etc). Tobacco flavors, and traditional tobacco top flavors may be used to impart a rich tobacco flavor. Sustained release flavors, coated particle flavor systems, and flavor capsules with volatile flavors may all be employed. Breakable flavor units (like those crushed by the user in a cigarette filter) may be employed to keep volatile flavors fresh. Flavors may be employed in the amount of 0.1-25% of the final composition, preferably 8-20% of the final composition.

Penetration agent(s) may be added to the tobacco wax. By penetration agents, we mean an agent that promotes transfer of the active—i.e., a substance that enhances absorption through the mucosa, mucosal coating and epithelium. otherwise known (see U.S. Patent Application Publication No. 2006/0257463 A1, the content of which is incorporated herein by reference). The penetration agent may comprise but is not limited to polyethylene glycol (PEG), diethylene glycol monoethyl ether (Transcutol), 23-lauryl ether, aprotinin, azone, benzalkomin chloride, cetylpendium chloride, cetylmethylammonium bromide, dextran sulfate, lauric acid, lauric acid/propylene glycol, lysophosphatilcholine, menthol, methoxysalicylate, oleic acid, phosphaidylcholine, polyoxyethylene, polysorbate 80, sodium EDTA, sodium glycholated, sodium glycodeoxycholate, sodium lauryl sulfate, sodium salicylate, sodium taurocholate, sodium taurodeoxycholate, sulfoxides, and various alkyl glycosides or, as described in U.S. Patent Application Publication No. 2006/0257463, bile salts, such as sodium deoxycholate, sodium glycodeoxycholate, sodium taurocholate and sodium glycocholate, surfactants such as sodium lauryl sulfate, polysorbate 80, laureth-9, benzalkonium chloride, cetylpyridinium chloride and polyoxyethylene monoalkyl ethers such as the BRIj® and MYRJ® series, benzoic acids, such as sodium salicylate and methoxy salicylate, fatty acids, such as lauric acid, oleic acid, undecanoic acid and methyl oleate, fatty alcohols, such as octanol and nonanol, laurocapram, the polyols, propylene glycol and glycerin, cyclodextrins, the sulfoxides, such as dimethyl sulfoxide and dodecyl methyl sulfoxide, the terpenes, such as menthol, thymol and limonene, urea, chitosan and other natural and synthetic polymers. Preferably, the penetration agent is selected to be capable of transfer through vaporization.

Buffer agents may be added to the tobacco wax, including without limitation to create static or a dynamic buffer systems. Preferably, the buffer agent is used to raise the pH of the mouth in order to increase nicotine absorption in the buccal cavity in a manner which is based on pka and the Henderson Hasselbach equation. For nicotine, preferably, the pH of the mouth is increased to 7 to 10, preferably 7.8 to 10, most preferably from 8.5 to 9.5. Preferably, the buffer agent increases the pH of the oral cavity for a period of ten minutes or more after administration

Buffering agents may be used to control pH, including without limitation, sodium bicarbonate, potassium bicarbonate, sodium carbonate, potassium carbonate, calcium carbonate, dipotassium phosphate, potassium citrate, sodium phosphate and any other such buffer system. The buffer system may be designed to dynamically control the pH of the product taking into consideration the effect of saliva during use, i.e., a dynamic buffer system. Examples of buffer systems to obtain the preferred pH include dibasic sodium phosphate and monobasic sodium phosphate. Both are FDA accepted buffer materials used and listed in the inactive ingredients list. For example, for a pH of 7, the ratio of monobasic/dibasic can be 4.6/8.6; for a pH of 7.5 the ratio of monobasic/dibasic can be 1.9/11.9; and for a pH of 8.0 the ratio of monobasic/dibasic can be 0.6/13.4. These are mathematically calculated buffer numbers and will need to be adjusted according to the other ingredients added to the formula. Thus this dynamic buffer range is adjusted by the amounts of the buffer system since saliva is freshly renewable in the mouth. See Fusz U.S. Patent Application Publication Nos. 2009/0098192 A1 and US 2011/0318390 A1 discussing dynamic buffering and incorporated herein by reference.

Preservatives may be added to the tobacco wax to preserve freshness and inhibit microbial growth.

Preferably, the wax composition has maintains a wax like viscosity and/or consistency despite the addition of any excipients. It is generally advantageous that the tobacco wax composition does not flow until under heavy-vaporizing heat. However, it may be beneficial to adjust the rheological properties of the tobacco wax composition. For example, a reduced viscosity and or surface tension may be desired for various reasons, such as packaging convenience (e.g a squeezable tube may be easier to use with reduced viscosity). It may also be beneficial to increase viscosity, for example to prevent flow off a flat heating surface (e.g. a hookah platform. Etc.). Rheology agents may employed to adjust the viscosity, surface tension and other rheological properties of the final product (e.g. gelling agents, tween, etc), including at different temperature ranges.

The resulting tobacco wax composition may be used by itself, or mixed with other vaporizable compositions (which may comprise solid and/or liquid formats). Such mixing may be done by the manufacturer or by the user. Liquid formats including without limitation e-liquid type products. Solid formats include without limitation other waxes from tobacco or other plant or botanical materials. Mixing can also take place by blending the plant or botanical materials which are subjected to the extraction process.

The wax composition of the present invention is intended to be vaporized. Suitable devices include any device capable of sufficiently heating the composition to cause it to vaporize and still not substantially burn the composition. Non-limitative examples of suitable devices include devices marketed as dry herb vaporizers. Suitable temperature ranges for the vaporizer heating element range from temperature needed to vaporize the composition and below the auto ignition temperature of the composition.

Suitable battery parameters ranging from 1 Amp continuous output to 30 Amp continuous output.

The wax composition of the present invention is substantially vaporizable, meaning that it will be substantially vaporized when heated in a suitable device. It is desirable that residue is minimized, including inter alia to avoid the need to clean the device between uses.

The tobacco wax composition of the present invention when vaporized, emits lower levels or HPHC's than conventional tobacco products, e.g. cigarettes. The tobacco wax composition, when used in a suitable vaporizer, results in less than 25%, on average, of the levels of HPHC's from a US-sold Marlboro Red (using comparable methods to measure e.g. Canadian method), preferable less than 10% and most preferably less than 5%. It is desirable to mitigate the levels of tobacco specific nitrosamines in the composition. The tobacco wax composition has TNSA levels preferably less than 10 parts per million (ppm, more preferably less than 3 ppm, most preferably less than 1 ppm.

In another aspect, the present invention relates to a portion-sized container (“pod”) of a tobacco wax composition for administration to a mammal or person. The pod is intended for use in a personal (or other) vaporizer.

The pod is most commonly in a cup like shape. The top is commonly open, and temporarily covered by a covering that is removed just prior to, or in connection with use of the portion sized container.

By portion-sized, the portion may be for multiple uses and sessions by the user. The tobacco wax composition portion may range from 1 mg to 3 grams, preferably from 100 mg to 2 grams, most preferably 100 mg to 0.4 grams.

The pod is received, or mated to a receiving chamber. The receiving chamber comprises—or is adjacent to—the heating system. The receiving chamber and pod are shaped to maintain close contact, with the absence or substantial absence of air between the two respective surfaces (so the pod surfaces are substantially in contact with the receiving chamber). This promotes heat transfer from the receiving chamber to the pod.

Preferably, the receiving chamber comprises a ceramic type material (e.g. porcelain or ceramic). More preferably, the ceramic type material is a positive temperature coefficient (PTC) ceramic, allowing the receiving chamber itself to serve as a heating element or heat source.

In a preferred embodiment, the PTC ceramic (or comparable receiving chamber material) is composed such that the Curie point discourages or retards heating of the tobacco wax composition above a high (upper) threshold temperature.

High threshold temperatures may be associated with toxicant and degradant production and are to be avoided regardless of the method in which the receiving chamber is heated. It is preferable that the tobacco wax composition in the pod not be heated to greater than 800 F, preferably less than 500 F, more preferable less than 400 F, and most preferably under 300 F. Relatively low temperatures may be employed given the propensity of the tobacco wax composition of the present invention to vaporize. A preferred operating temperature range is 225 F to 350 F, or 250 F to one of the temperature bounds set forth in this paragraph. In any case, in the preferred embodiment, a upper threshold temperature is not exceeded, or not generally or likely to be exceeded in normal consumer use.

At the same time, it is desirable that that the device be capable of rapidly reaching operating temperatures (without overshooting target operating temperatures or exceeding high threshold temperatures), or otherwise sufficient temperatures. Preferably, the device is capable of heating the tobacco wax composition in the pod reach the preferred operating temperature range rapidly, meaning in less than 10 seconds, preferably in less than 5 seconds, more preferably in less than 2 seconds, most preferably in less than 1 second.

By “otherwise sufficient temperatures” Applicants refer to temperature at which the tobacco wax composition readily vaporizes.

While ignition of the tobacco wax composition is unlikely, it is an express intention that the tobacco wax not be ignited or otherwise burned by or in the device.

Airflow is an important feature of a vaporizer system, for the user experience.

It is desirable to have no or effectively no bottom airflow into the cup. Bottom airflow is the primary design currently used in cigarettes and vapor pens. Bottom airflow directs air directly over the heating coil (where vapor is created). The wick for e-liquid helps to prevent leaking of the e-liquid.

In a system for the tobacco wax composition, wicking is not possible. The tobacco wax composition will simple not wick as a conventional e-liquid will. Moreover, an unplugged bottom hole is problematic with tobacco wax. This is because hot wax will tend to leak down, re-solidify and clog the bottom airflow (leakage of a conventional e-liquid in a convention tank is unpleasant but does not clog the device in a disabling manner). Moreover, the now solid tobacco wax is fairly difficult to remove. Side airflow, and/or top airflow is less likely to clog and is thus preferred (either in whole, in part, or substantially).

In both top and side airflow, turbulence is relied upon to mix air currents with vapor, since the prevailing airflow is towards the mouthpiece (and the vacuum created by the user's inhalation).

In the present invention, the tobacco wax composition containing pod is heated. Vapor forms—often at the bottom and sides of the pod closest to the heat, and the wax product is vaporized (and climbs through the top of the wax product).

The closer the airflow is to the top of the tobacco wax composition product, the easier it is for turbulence to join the vapor into the prevailing airflow. Thus it is desirable to have side airflow occur in relatively close proximity to the top of the composition product level. However, if the side airflow is too close to the top of the composition product level then the side airflow holes will be more prone to blockage.

Side airflow may enter through the sides of the pod. In this embodiment, the pod itself has holes that correspond to side airholes located in the sides of the receiving chamber (and permitting airflow, being connected to the outside of the vaporizer). Such side holes in the pod are covered prior to use (to protect the product), and such cover is removed by the user prior to use or automatically by the device.

It is also possible for the device to create side airholes in the pod material (as opposed to removing the covering from pre-formed airholes), where a relatively weak material is used that can be readily punctured.

The side airflow must enter above the tobacco wax composition product fill level (as distinct from the top of the pod).

The product fill level must be calibrated to the location of the side airholes, if any, in the sides of the pod. Side airflow (and airholes) may also enter from the side of the receiving chamber above the top of the pod. Where there are side airholes above the top of the pod, similarly the product fill level is still calibrated to the distance from the product fill to the airholes. If the distance is too short, blockage is more likely. Similarly, if the distance is too long vapor production will be lessened. In certain non-limitative embodiments, the side airholes are less than 4 mm from the starting product fill level, preferably less than 2 mm from the starting product fill level, preferably more than 0.5 mm from the starting fill level, and more preferably more than 1 mm from the starting fill level.

Side airholes may be directed downwards (i.e. at a downwards trajectory) to increase the air vortices and turbulence.

Airholes may be protected from wax blockage in a number of ways. First, a physical obstruction may be employed (e.g. a physical lip). Such physical obstructions can make it harder for melted wax to flow into the airhole (particularly when the user physically moves the pen during use—for example, starting with a vaporizer perpendicular to the flow and then moving the vaporizer to a parallel position for use). Similarly, materials (including coatings) may be selected to minimize or direct the flow of liquid wax away from the airholes to prevent blockage. Physical channels (e.g.) grooves may be similarly employed to direct the flow if liquid wax away from the airholes.

Placement of airhole locations can be oriented to avoid or reduce blockage. Typically, the personal vaporizer may be raised to mouth of a user and held parallel to the ground when used. However, in a conventional vaporizer, there is no way to predict how the vaporizer will be oriented by the user. A conventional heat button can be readily used by the thumb or an opposing finger, and is not a good predictor for orientation (although the user will typically have the battery button pointing up or down). The mouthpiece however can be shaped in such a way that is intuitive to the user to orient the vaporizer in a certain direction (as a non-limitative example, a plastic cigarillo tip is typically formed in a way that a user would know how to orient the cigarillo). In this embodiment, the side airholes can be oriented such that the airholes are biased to the up-wards plane when the vaporizer is oriented parallel to the ground plane (since we know how the user will orient the vaporizer because of the mouthpiece. For example, three airholes may be used (in the receiving chamber potentially with aligned pod holes) that are positioned with a bias against the downward side (meaning the airholes are biased towards the upward side when the device is uses as expected including through use of a shaped or marked mouthpiece).

The vaporizer, pod and/or receiving chamber may have up to ten side airholes, preferably 2-6 side airholes most preferably 3-5 side airholes. Where a mesh or similar covers the airhole opening, the number of airholes would be understood to be the number of air channels.

The device may similarly be marked or shaped on a part of the device other than the mouthpiece to indicate a desired orientation (with corresponding placement of airholes as described above to reduce blockage potential). For example and without limitation, shape indentations may be provided to signal a desired holding of the device in the hand.

In certain non-limitative embodiments, the pod has a diameter of 3-15 mm, preferably 6-10 mm (with a corresponding internal diameter for the receiving chamber).

In certain non-limitative embodiments, the pod has a height of 0.5 to 22 mm, preferably 2 to 10 mm (with a corresponding size for the receiving chamber).

Heated tobacco wax compositions in a pod can be explosive (in terms of physical motion—not ignition) when wax at the bottom of a pod is vaporized, and the vapor pressure is such as to disrupt the wax above to allow the vapor to escape. It is desirable to have a “shield”—a physical obstruction that prevents direct passage of heated tobacco wax composition material from the pod or cup to the mouthpiece. Generally the shield is attached to the mouthpiece (but it may equally attach to other parts of the vaporizer). The shield may also employ features intended to increase airflow turbulence, without adversely effecting the user's “draw” on the vaporizer.

The Pod may similarly be designed to minimize the possibility of wax explosions. For example (and without limitation), a rim or brim on the pod may act in the same manner as the shield to obstruct wax explosions from traversing the mouth piece.

The pod-receiving chamber may have a rail, slot or comparable alignment interface to ensure the pod is appropriately aligned in the receiving chamber so that the airholes from the receiving chamber align or substantially align with the pod airholes. In this embodiment, the pod has complimentary features to mate with the alignment interface. Such alignment may also be used for other purposes, i.e. to facilitate other connections between pod and receiving chamber (e.g. data link, ejector system, etc).

The vaporization device may have an ejection system to facilitate ejection of the pod from the receiving chamber (as opposed to relying upon shaking or use of inertia to evacuate the pod). Such system may comprise, without limitation, a physical ejector to lift the pod out of the receiving chamber.

A mouthpiece sits above the pod-receiving chamber assembly. The mouthpiece employs a combination of distance and relatively low heat transfer properties to ensure the mouthpiece is not uncomfortably warm for the user. The mouthpiece may be integrated with a shield and/or a device to increase turbulent airflow.

In certain embodiments, the pod itself may be fashioned from a material that heats, e.g. a PTC ceramic. Other materials may also be used that heat when electric current is supplied. In this embodiment, the receiving chamber acts as a physical receiving area, may provide airflow (airholes) and may integrate power to the pod. The pod may further comprise a thermistor to measure temperature, either of the pod itself or wax contained therein.

Empty pods may also be offered to allow the user to treat the device as an open system (meaning they can use their own vaporizable materials).

The pod may be made from any suitable material. Special care must be given that the pod material does not emit undesirable elements when heated. The material will generally be a solid material, but flexible materials may also be employed.

While a pod with a flat or substantially flat bottom surface is desirable for handling by the consumer, other shapes may be used. Specifically, a shape whereby the cup is half a circle will mean reduce mean geographic distance from the receiving chamber walls. Other shapes can be selected with this same purposes, i.e. to reduce geographic distance. Corners may, ceteris paribus, create higher heat areas within the tobacco wax contained in the pod.

The top of the pod may be configured to allow for easy access by a consumer. This allows a consumer to add other waxes or extracts to the Pod. Conversely, the system may be configured to make it difficult for a consumer to add their own materials to the pod.

A temperature meter can be built into the pod, the receiving chamber, or both. The pod and receiving chamber are used as part of a vaporizing system, further comprising a power source (typically electric, but it may also be a carbon-based source, or butane based source or other source of heat), and a control module that allows the user to select heat settings, turn the device on or off, as well as other features. The device may be able to store and communicate use data.

The Pod may be able to communicate to the device (or the device determine from the Pod) the type of Pod (flavor, quantity of wax composition, nicotine strength, etc).

The use of the pod is not limited to tobacco wax compositions but may also be employed with other botanical or plant wax compositions, as well as e-liquids. Such materials may be used in combination with tobacco wax. References herein to tobacco wax compositions can also refer to these products and compositions comprising them. All references herein to wax may compromise oleoresins.

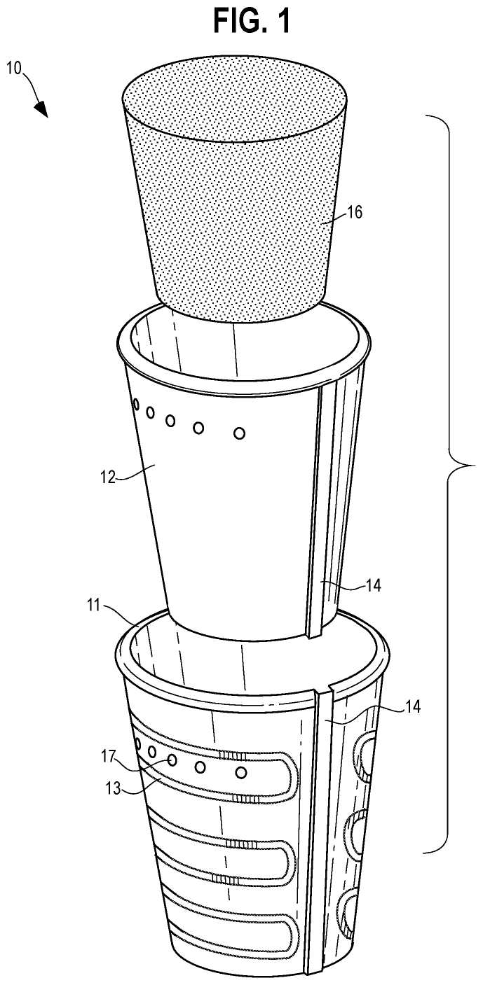

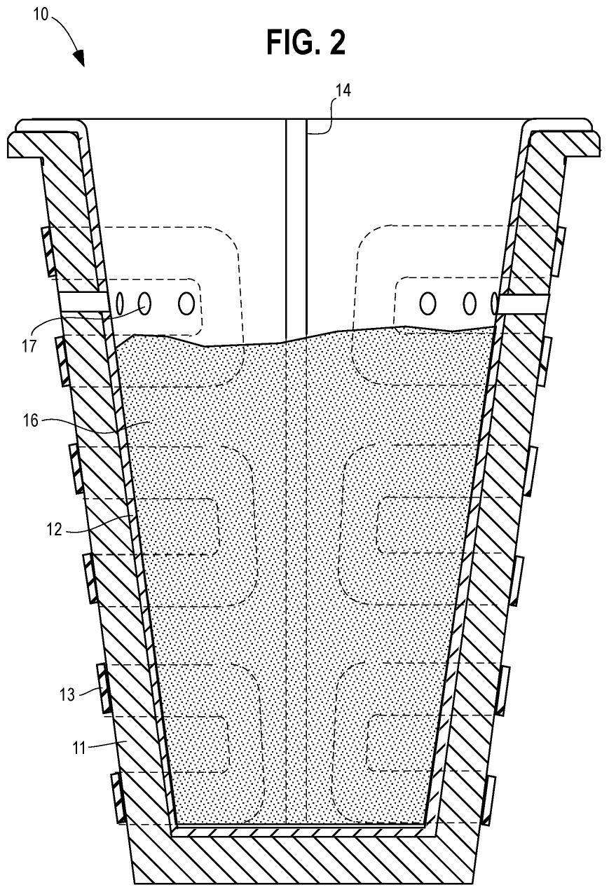

FIG. 1 shows an exploded view personal vaporizer 10 of the present invention including a receiving chamber 11 and a pod 12. FIG. 2 shows a cross-sectional view of the receiving chamber 11 and pod 12. The receiving chamber 11 has a heater 13, an alignment interface 14 and side airholes 15. The pod 12 contains a tobacco wax composition 16 and has side airholes 17 that align with the side airholes 15 of the receiving chamber 11. Preferably, a distance from a starting product fill level 18 of the tobacco wax composition 16 in the pod 12 to the airholes 17 is less than 4 mm.

### Example A

Tobacco wax was removed from tobacco leaf using supercritical CO2 extraction. Tobacco oil was mixed in with the wax, while retaining a wax consistency. The material was fragrant and dark brown in color. A nicotine assay indicated a nicotine strength for the tobacco wax of 4%. The wax was placed in a dry herb vaporizer and vaped by a healthy adult male. The tobacco wax vaporized creating a nice vapor volume. The nicotine delivery was strong and the product was fragrant with tobacco fragrance. The tobacco wax substantially vaporized leaving minimal residue on the heating coil.

### Example B

The tobacco wax of Example A was taken and 10% of vegetable glycerin and 5% of propylene glycol (measuring by weight of the final composition) was added. The tobacco wax accepted the addition of these vapor agents. The resulting composition was placed in a dry herb vaporizer and used by a healthy adult male. The flavor was excellent and the vapor production was increased from Example A.

### Example C

The tobacco wax of Example A was taken and grape flavor from Tobacco Technology, Maryland was added, at 3.5% of the composition. The resulting tobacco wax composition was placed in a dry herb vaporizer and used by a healthy adult male. The grape taste was enjoyed by the user.

### Example D

Tobacco wax was extracted from a different of blend tobacco leaf using supercritical CO2 extraction. The tobacco wax was dark with a slightly green tinge. The nicotine content of the tobacco wax was approximately 1.5%. Nicotine glycerin solution (10%) was added to 10% of the final composition weight. The product vaped well but the flavor notes where not as attractive as the tobacco wax of Example A. It was observed that additional flavors could improve the product.

### Example E

Oil from the extraction of tobacco described in Example D was added to the tobacco wax of Example D, and the composition was mixed using strong shear forces. The resulting product vaped well and left very little residue.

### Example F

The tobacco wax of example D was mixed with glycerin in ration of 50-50%. The resulting tobacco wax composition was still very wax like in consistency and produced very large amounts of vapor when used in a vaporizer.

### Example G

Tobacco wax from Example A was placed in a vaporizer. A small amount of zero nicotine flavored e-liquid was added to the vaporizer. The two were not otherwise mixed other than to insert them together. The wax and the zero were vaporized together. A fair amount of residue was left by this mix in the vaporizer. The exercise was repeated with a yet smaller amount of e-liquid with improve results including much less residue.

### Example H

Tobacco wax from Example A was compounded with a small amount of sodium carbonate as a buffer agent to effect a more basic pH.

What is claimed is:

1. A system for a personal vaporizer comprising a receiving chamber and a pod containing a tobacco wax composition including tobacco wax extracted from one or more of tobacco leaf, tobacco stem or tobacco dust, the pod being in contact with the receiving chamber.
